(19) United States
(12) Patent Application Publication
(10) Pub. No.: US 2026/0214242 A1
(43) Pub. Date: Jul. 23, 2026

(54) REGRESSION BASED INTRA PREDICTION BLENDING

(71) Applicant: InterDigital CE Patent Holdings, SAS, Paris (FR)

(72) Inventors: Philippe Bordes, Laille (FR); Thierry Dumas, Rennes (FR); Franck Galpin, Thorigne-Fouillard (FR); Karam Naser, Mouazé (FR)

(73) Assignee: InterDigital CE Patent Holdings, SAS, Paris (FR)

(21) Appl. No.: 19/140,343

(22) PCT Filed: Dec. 20, 2023
(86) PCT No.: PCT/EP2023/086984

§ 371 Date: Jun. 17, 2025

(30) Foreign Application Priority Data
Dec. 23, 2022 (EP) 22307027.7

(51) Int. Cl. H04N 19/159; G06V 10/50; H04N 19/176; H04N 19/593

(52) U.S. Cl. CPC H04N 19/159; G06V 10/50; H04N 19/176; H04N 19/593

(57) ABSTRACT

Systems, methods, and instrumentalities are disclosed for performing regression-based intra prediction mode (IPM) blending. Regression-based intra prediction may be computed (e.g., iteratively computed) as a linear combination of parameters derived from the template. A video decoding device may be configured to obtain a template associated with a block, including reconstructed samples and corresponding predicted samples of the template. The video decoding device may determine weights based on minimizing a difference of the predicted samples and the corresponding reconstructed samples. The video decoding device may apply the weights to respective parameters to determine an intra prediction model. Parameters may include reconstructed samples and/or iteratively derived prediction samples that neighbor a sample location. The video decoding device may determine intra prediction samples for the block based on the intra prediction model. The predicted samples, corresponding reconstructed samples, and intra prediction samples may share a component type.

### CROSS REFERENCE TO RELATED APPLICATIONS

This application claims the benefit of European Provisional Patent Application No. 22307027.7, filed Dec. 23, 2022, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

A video decoding device may be configured to obtain a template associated with a block, including reconstructed samples and corresponding predicted samples of the template. The video decoding device may determine weights based on minimizing a difference of the predicted samples and the corresponding reconstructed samples. The video decoding device may apply the weights to respective parameters, for example to determine an intra prediction model. Parameters may include reconstructed samples that neighbor a sample location and/or iteratively derived prediction samples (e.g., obtained based on intra prediction modes). The video decoding device may determine intra prediction samples for the block based on the intra prediction model. The predicted samples, corresponding reconstructed samples, and intra prediction samples may share a component type. For example, the predicted samples, corresponding reconstructed samples, and intra prediction samples may be luma samples. For example, the predicted samples, corresponding reconstructed samples, and intra prediction samples may be chroma samples. The video decoding device may decode the block based on the intra prediction samples.

The video decoding device may obtain reference samples of the template (e.g., predicted samples) and may optimize the weights that correspond to the reference samples of the template based on minimizing the difference of the sum of the weighted reference samples and the reconstructed samples of the template.

The intra prediction sample may be associated with a sample location in the block and the parameters may include predicted samples that neighbor the sample location. The video decoding device may determine the intra prediction sample for the block based on the intra prediction model by, for example, applying the determined weights to the predicted samples that neighbor the sample location.

The intra prediction model may include applying the weights to respective reconstructed samples that neighbor a sample location to determine an intra prediction sample. The intra prediction sample may be associated with a sample location in the block. The parameters may comprise reconstructed samples that neighbor the sample location. The video decoding device may for a second sample location in the block, identify predicted samples that neighbor the second sample location. The video decoding device may apply the determined weights to the predicted samples that neighbor the second sample location to determine a second intra prediction sample for the block. The block may be decoded further based on the second intra prediction sample of the block. The predicted samples that neighbor the second sample location may include the first intra prediction sample. For example, derivation of intra prediction samples may be regression-based and/or iterative.

The intra prediction model may include applying the weights to respective prediction samples obtained based on different derived prediction modes. The video decoding device may derive intra prediction modes based on reconstructed samples and reference samples of the template. The parameters may correspond to prediction samples obtained based on the derived intra prediction modes. Determining the intra prediction sample for the block based on the intra prediction model may include applying the weights to the prediction samples obtained based on the derived intra prediction modes.

The video decoding device may obtain a histogram of gradients associated with samples of the template. The video decoding device may derive intra prediction modes based on the histogram of gradients associated with the template. The prediction samples of the template may be obtained based on the respective derived intra prediction modes, and the parameters may correspond to prediction samples obtained based on the derived intra prediction modes.

The intra prediction model may include applying the weights to respective prediction blocks obtained based on different derived prediction modes. The video decoding device may derive intra prediction modes, for example, based on reconstructed samples of the template. The video decoding device may obtain a prediction sample of the block based on the derived intra prediction modes. The video decoding device may blend prediction samples based on the weights.

The video decoding device may derive a intra prediction modes, for example, based on reconstructed samples of the template. The video decoding device may obtain weighted and blended predictions of the template based on derived intra prediction modes. In examples, each of the weighted and blended predictions of the template sample may correspond to a respective reconstructed sample of the reconstructed samples in the template. The video decoding device may optimize the weights that correspond to the derived intra prediction modes based on minimizing a difference of the weighted and blended predictions of the template and the reconstructed samples in the template.

A video encoding device may be configured to obtain a template associated with a block. The video encoding device may obtain predicted samples and corresponding reconstructed samples of the template. The video encoding device may determine weights based on minimizing a difference of the predicted samples and the corresponding reconstructed samples of the template. The video encoding device may determine an intra prediction model that comprises applying the weights to respective parameters. The video encoding device may determine an intra prediction sample for the block based on the intra prediction model. The predicted samples, the corresponding reconstructed samples, and the intra prediction sample share a component type (e.g., chroma, luma). The video encoding device may encode the block based on the intra prediction sample.

The video encoding device may obtain reference samples of the template. The weights may correspond to the reference samples of the template. The video encoding device may optimize the weights based on minimizing a difference of a sum of weighted reference samples and the reconstructed samples of the template.

The intra prediction sample may be associated with a sample location in the block and the parameters may comprise predicted samples that neighbor the sample location. The video encoding device may determine the intra prediction sample for the block based on the intra prediction model by, for example, applying the determined weights to the predicted samples that neighbor the sample location.

The intra prediction sample may be a first intra prediction sample and may be associated with a first sample location in the block. The parameters may comprise reconstructed samples that neighbor the first sample location. The video encoding device may, for a second sample location in the block, identify predicted samples that neighbor the second sample location. The video encoding device may apply the determined weights to the predicted samples to determine a second intra prediction sample for the block. The block may be decoded based further on the second intra prediction sample of the block. The predicted samples that neighbor the second sample location may include the first intra prediction sample.

The video encoding device may derive intra prediction modes based on reconstructed samples of the template and reference samples of the template. The parameters may correspond to prediction samples obtained based on the derived intra prediction modes. The video encoding device may determine the intra prediction sample for the block based on the intra prediction model by, for example, applying the weights to the prediction samples obtained based on the derived intra prediction modes.

The video encoding device may obtain a histogram of gradients associated with samples of the template. The video encoding device may derive intra prediction modes based on the histogram of gradients associated with the template. The prediction samples of the template may be obtained based on the respective derived intra prediction modes, and/or the parameters may correspond to a prediction samples obtained based on the derived intra prediction modes.

The video encoding device may derive intra prediction modes based on at least on reconstructed samples of the template. The video encoding device may obtain prediction samples of the block based on the derived intra prediction modes. The video encoding device may blend the prediction samples based on the weights.

The video encoding device may derive intra prediction modes based on at least on reconstructed samples of the template. The video encoding device may obtain weighted and blended predictions of the template based on the derived intra prediction modes. In examples, each of the weighted and blended predictions of the template may correspond to a respective reconstructed sample of the reconstructed samples in the template. The video encoding device may optimize weights that correspond to the derived intra prediction modes based on minimizing a difference of the weighted blended predictions of the template and the reconstructed samples in the template.

Systems, methods, and instrumentalities are disclosed for performing regression-based intra prediction mode (IPM) blending. Intra prediction blending weights may be derived for template-based intra mode derivation (TIMD) and decoder side intra mode derivation (DIMD), for example, using a regression-based method. Intra prediction samples may be generated from regression-based locally computed parameters on the neighboring samples. Regression-based weights may be derived for TIMD. IPM blending weights may be derived for the selected TIMD modes (e.g., with the smallest sum of absolute transformed differences (SATD) costs). Regression-based weights may be derived for DIMD. IPM blending weights for the selected intra DIMD modes (e.g., with the tallest histogram bars) and the weight of the PLANAR mode may be determined using the regression-based method. Regression-based intra prediction may be computed as a linear combination of parameters derived from the template. Parameters derived from the template may include the reconstructed reference sample (e.g., chroma, luma) in the same column or same line as the sample in the template or the position of the reconstructed reference sample (e.g., the value). Regression-based intra prediction may be iterative. One or more parameters (e.g., all parameters) may be derived iteratively from previously predicted sample values of the current block. For example, parameter(s) may include predicted samples neighboring the current intra prediction sample. For example, the intra prediction parameters may depend on (e.g., only depend on) neighboring reference samples. The intra prediction sample may be a block, a subblock, or a sub-subblock (e.g., a pixel or plurality of pixels). Regression-based model derivation may be implemented with local adaptation. Intra prediction may be adapted spatially, e.g., depending on histogram of oriented gradients (HoG) costs (e.g., DIMD) and/or SATD costs (e.g., TIMD). Spatial adaptation may be implemented with spatial weighting. Weighting adaptation may be combined with a variety of implementations, for example, using spatially adapted weighting in IPM blending.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example definition of samples used by PDPC applied to diagonal top-right mode.

FIG. 6A illustrates an example of a template area and reference samples that may be used for deriving template-based intra mode derivation (TIMD) modes and associated weights.

FIG. 6B illustrates an example of reference samples that may be used to derive an intra prediction for the current block.

FIG. 7 illustrates an example of derivation of the blending weights for decoder side intra mode derivation (DIMD).

FIG. 8 illustrates an example using neighboring reconstructed samples for DIMD chroma mode.

FIG. 9 illustrates an example of a spatial part of a convolutional filter.

FIG. 10 illustrates an example of a reference area that may be used to derive the filter coefficients.

FIG. 11 illustrates an example of spatial samples used for GL-CCCM.

FIG. 12 illustrates an example of neighboring regions used to derive the CC-model.

FIG. 13A illustrates an example of using template and reference samples to derive an intra prediction model.

FIG. 13B illustrates an example of using reference samples to apply the intra prediction model.

FIG. 14 illustrates an example of applying the prediction model iteratively.

FIG. 15 illustrates an example of using spatial varying weights for deriving the blending model.

FIG. 16 illustrates an example of deriving blending parameters with spatially varying blending weights.

### DETAILED DESCRIPTION

A more detailed understanding may be had from the following description, given by way of example in conjunction with the accompanying drawings.

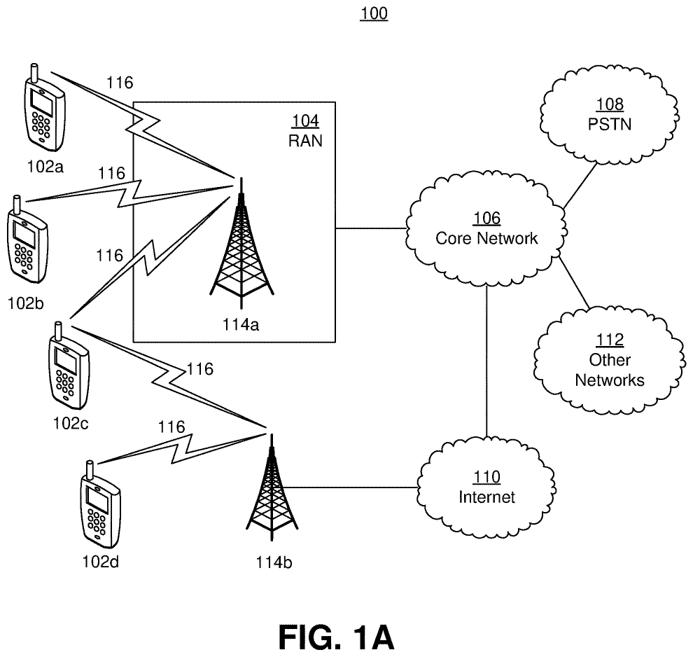

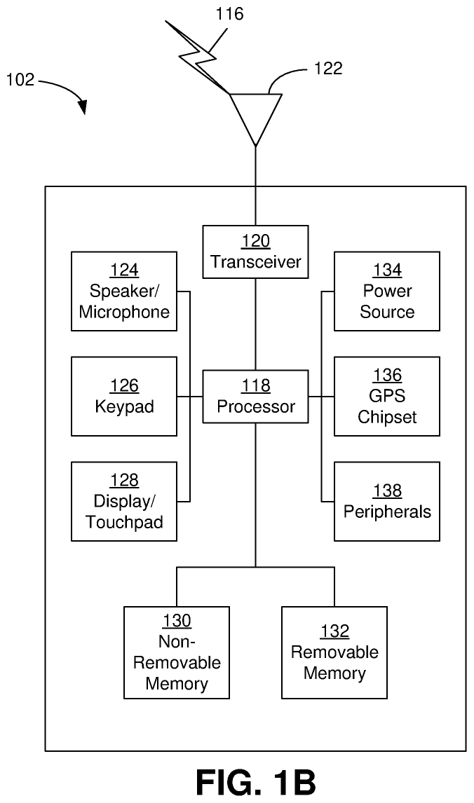

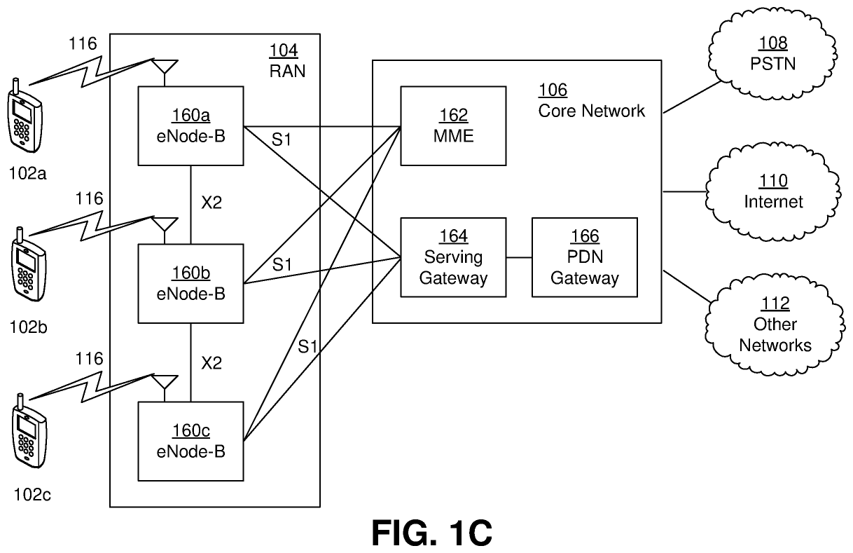

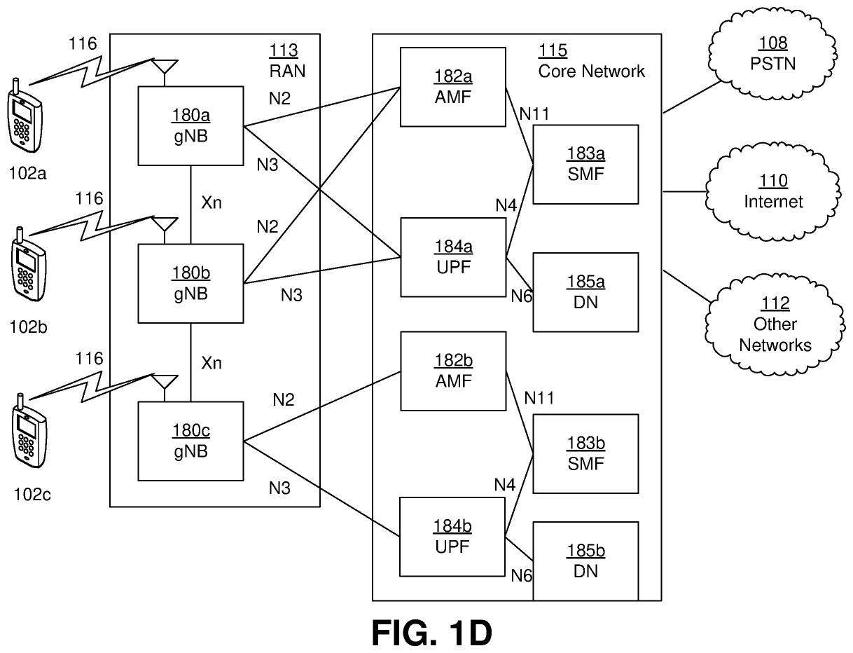

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

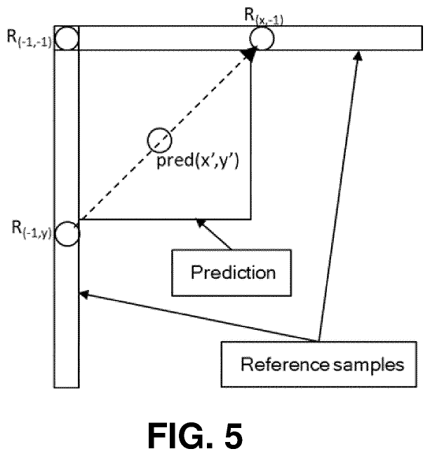

The aspects described and contemplated in this application may be implemented in many different forms. FIGS. 5-16 described herein may provide some examples, but other examples are contemplated. The discussion of FIGS. 5-16 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

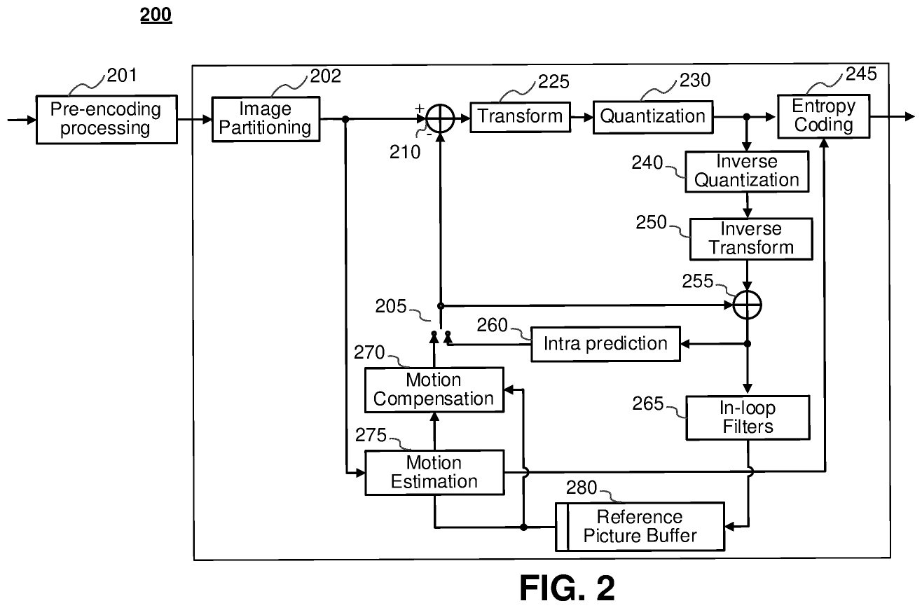

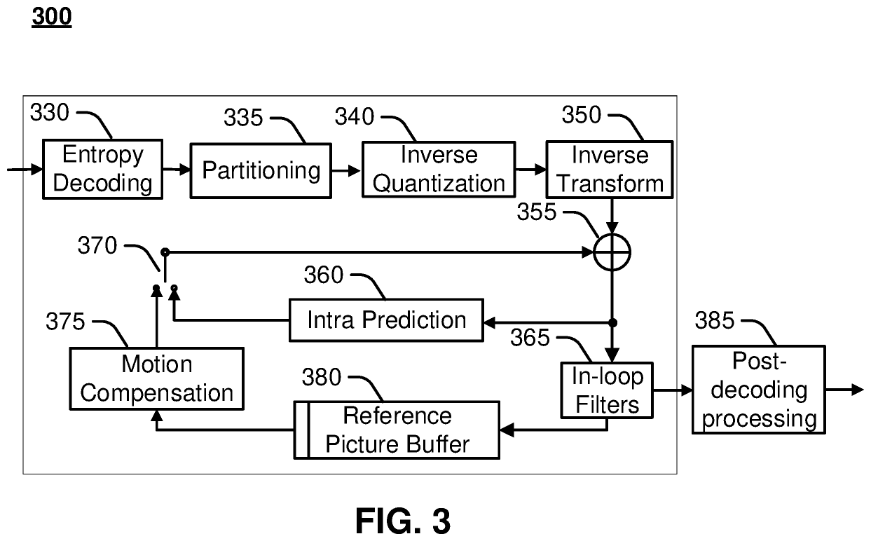

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as a number of weights, weight values, a number of taps in filters, a number of bits in content, a scalar offset, matrix dimensions, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

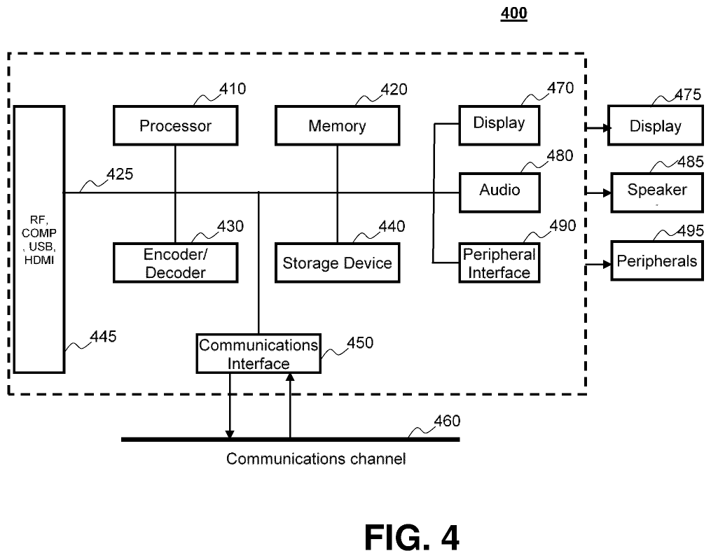

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, residual signals, metadata, intra prediction signals, selected regions for reference samples, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

The results of intra prediction of DC, planar, and/or other angular modes may be modified, for example, by a position dependent intra prediction combination (PDPC) method. PDPC is an intra prediction method. PDPC may invoke a combination of the boundary reference samples and intra prediction with filtered boundary reference samples. PDPC may be applied, for example, to one or more of the following intra modes, for example, without signaling: planar, DC, intra angles less than or equal to horizontal, or intra angles greater than or equal to vertical and less than or equal to 80. PDPC may not be applied, for example, if the current block is block-based delta pulse code modulation (BDPCM) mode and/or if the multiple reference lines (MRL) index is larger than zero.

A prediction sample pred (x′,y′) may be predicted using an intra prediction mode (e.g., DC, planar, angular) and a linear combination of references, for example, in accordance with equation (1):

$$pred ( {x}^{′} , {y}^{′} ) = Clip ( 0 , ( 1 ≪ BitDepth ) - 1 , ( wL \times {R}_{- 1 , {y}^{′}} + wT \times {R}_{{x}^{′} , - 1} + ( 64 - wL - wT ) \times pred ( {x}^{′} , {y}^{′} ) + 32 ) ≫ 6 ) \qquad ( 1 )$$

With reference to equation (1), R_{x,-1}, R_{-1,y} may represent the reference samples located at the top and left boundaries of current sample (x, y), respectively.

Boundary filters (e.g., additional boundary filters) may not be needed (e.g., as they may be in the case of a DC mode boundary filter or horizontal/vertical mode edge filters), for example, if PDPC is applied to DC, planar, horizontal, and/or vertical intra modes. PDPC processes for DC and planar modes may be similar (e.g., identical). Left or top reference samples may not be used, respectively, if the current angular mode is HOR_IDX or VER_IDX. PDPC weights and scale factors may be dependent on prediction modes and/or block sizes. PDPC may be applied to a block having a width and a height greater than or equal to 4.

FIG. 5 illustrates an example definition of samples used by PDPC applied to diagonal top-right mode. In particular, FIG. 5 illustrates an example of the definition of reference samples (e.g., Rx,−1 and R−1,y) for PDPC applied over various prediction modes. A prediction sample pred (x′, y′) may be located at (x′, y′) within a prediction block. As an example, the coordinate x of the reference sample Rx,−1 may be given by: x=x′+y′+1, and the coordinate y of the reference sample R−1,y may be given by: y=x′+y′+1 (e.g., for the diagonal modes). The reference samples R_{x,-1} and R_{-1,y} may be located in a fractional sample position for the other angular mode. The sample value of the nearest integer sample location may be used (e.g., for fractional sample positions).

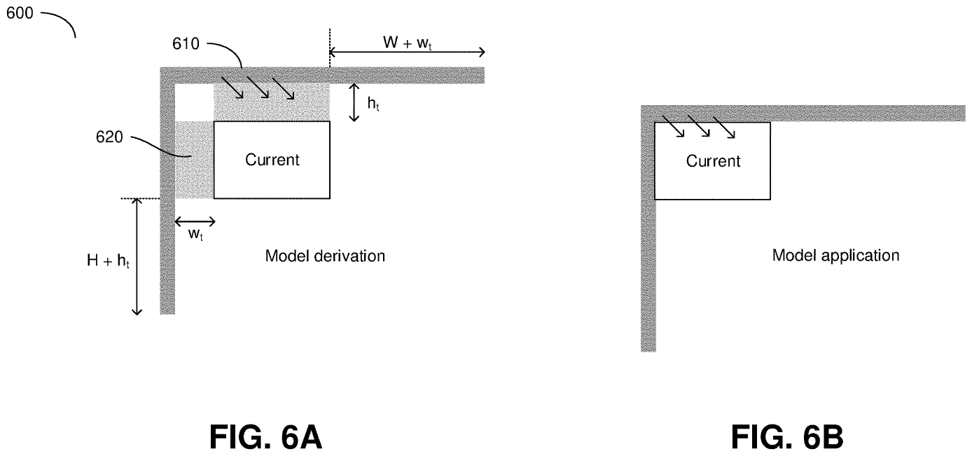

Template-based intra mode derivation (TIMD) may be implemented. FIG. 6A illustrates an example 600 of a template area 620 (e.g., in light grey) and reference samples 610 (e.g., in dark grey) that may be used for deriving TIMD modes and associated weights. FIG. 6B illustrates an example of reference samples (e.g., in dark grey) that may be used to derive an intra prediction for the current block.

The sum of absolute transformed differences (SATD) between the luminance prediction built with reconstructed reference samples of the template 610 and the reconstructed samples of the template 620 may be calculated for an intra prediction mode (e.g., each intra prediction mode) in most probable modes (MPMs) (e.g., supplemented with default modes PLANAR and DC, if needed). The first (e.g., two) intra prediction modes (IPMs) with the minimum SATD may be selected as the TIMD modes. The TIMD modes (e.g., two TIMD modes) may be fused with the weights (e.g., weight1, weight2), for example, after applying PDPC process. The weighted intra prediction may be used to code the current CU. PDPC may be included in the derivation of the TIMD modes.

The costs of the (e.g., two) selected modes (e.g., costMode1, costMode2) may be compared with a threshold. For example, the cost factor of TIMD mode 2 may be applied as follows. A condition may be, for example: costMode2<2*costMode1. The fusion may be applied, for example, if the condition is true. Mode 1 may be used, for example, if the condition is not true. Weights of the modes may be computed from their SATD costs, for example, in accordance with equation (2) and equation (3) as follows:

$$weight 1 = costMode 2 / ( costMode 1 + costMode 2 ) \qquad ( 2 )$$

$$weight 2 = 1 - weight 1 \qquad ( 3 )$$

In some examples, the number of weights may be increasing to N>2. In some examples, IPM_{A} may be determined as the IPM with minimum SATD with above template and/or IPM_{L} may be determined as the IPM with minimum SATD with left template. Fusion weights may vary spatially, for example, as a linear function of the distance to the above/left edge. Fusion weights may be determined, for example, in accordance with equation (4), equation (5), and equation (6) as follows:

$$If {SATD}_{A} > K \cdot {SATD}_{L} : {w}_{A} ( x , y ) = Clip 3 ( 0 , 64 , 32 + \frac{32 x}{W} - \frac{64 y}{H} ) \qquad ( 4 )$$

$$If {SATD}_{L} > K \cdot {SATD}_{A} : {w}_{A} ( x , y ) = Clip 3 ( 0 , 64 , 32 + \frac{64 x}{W} - \frac{32 y}{H} ) \qquad ( 5 )$$

$${w}_{L} ( x , y ) = 64 - {w}_{L} ( x , y ) \qquad ( 6 )$$

With reference to equation (4) and equation (5), K may be a pre-determined value (e.g., equal to 2) and (W×H) may be the current block size.

Decoder side intra mode derivation (DIMD) may be implemented. Intra modes (e.g., two intra modes) may be derived from the histogram of gradients (HoG) of the reconstructed neighbor samples, for example, if/when DIMD is applied. The HoG computation may be carried out, for example, by applying horizontal and vertical Sobel filters on pixels in a template (e.g., of width 3) around the block. The intra prediction modes corresponding to the (e.g., two) tallest histogram bars may be selected for the block.

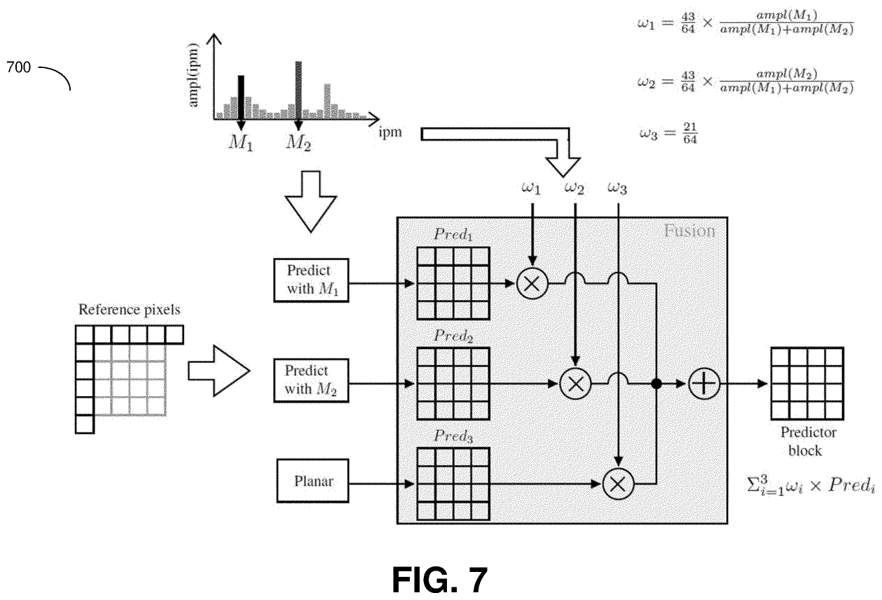

FIG. 7 illustrates an example 700 of derivation of the blending weights for DIMD. As shown, the (e.g., two) predictors may be combined with the planar mode predictor. The weights may be derived from the gradients, for example, as follows: (i) the weight of planar may be fixed to 21/64 (~1/3); and (ii) the remaining weight of 43/64 (~2/3) may be shared between the (e.g., two) HoG IPMs, proportionally to the amplitude of their HoG bars (e.g., as depicted in FIG. 7).

Derived intra modes may be included in the primary list of intra most probable modes (MPM). A DIMD process may be performed, for example, before the MPM list is constructed. The primary derived intra mode of a DIMD block may be stored with a block. The primary derived intra mode of a DIMD block may be used for MPM list construction of the neighboring blocks.

Multiple HoGs may be computed. In some examples, three (3) HoGs may be computed as follows: a HoG with above template, an HoG with left template, and an HoG with above+left template, which may allow for determining for an IPM (e.g., each of the two selected IPMs) whether the IPM depends on a specific template region. The location-dependency of IPMᵢ may be defined, for example, in accordance with all or a portion of the following logic: IPMi may depend on region ABOVE, for example, if (Habove[IPMi]>2.Hleft[IPMi]); IPMᵢ may depend on region LEFT, for example, if (H_{left}[IPMᵢ]>2.H_{above} [IPMᵢ]); and/or IPMi may not be location-dependent, for example, if otherwise.

The value of weighti may be adjusted (e.g., as a linear function of the distance to the above/left edge), for example, if the IPMi is location (above/left) dependent. The weight may be spatially varying (e.g., in accordance with equation (7)), for example, if the IPMᵢ is location above dependent:

$${wLocDepDimd}_{i} ( x , y ) = {wDimd}_{i} + {Δ}_{i} - 2 {Δ}_{i} \frac{y}{( H - 1 )} \qquad ( 7 )$$

The weight may be spatially varying (e.g., in accordance with equation (8), for example, if IPMᵢ is location left dependent:

$${wLocDepDimd}_{i} ( x , y ) = {wDimd}_{i} + {Δ}_{i} - 2 {Δ}_{i} \frac{x}{( W - 1 )} \qquad ( 8 )$$

With reference to equation (7) and equation (8), Ai may be a pre-defined weight range variation and (W×H) may be the current block size.

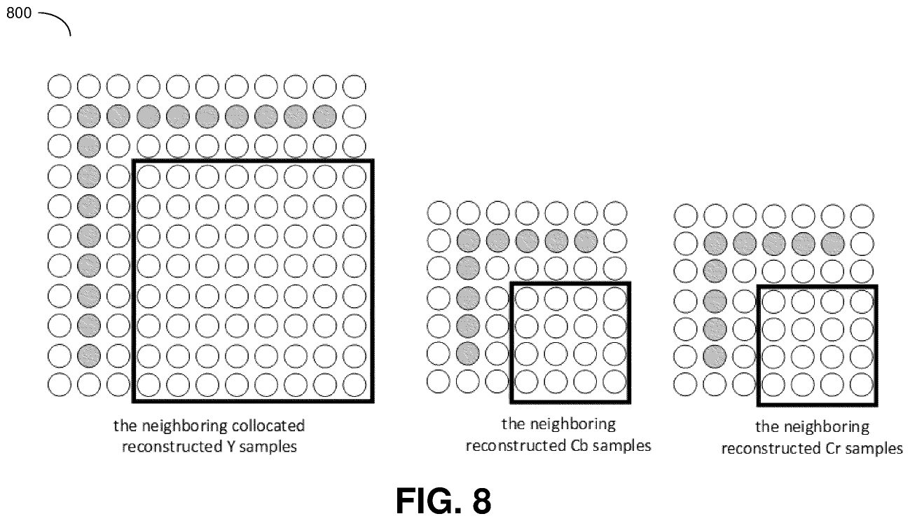

FIG. 8 illustrates an example (800) using neighboring reconstructed samples for DIMD chroma mode. As shown by example in FIG. 8, the DIMD chroma mode may use the DIMD derivation method to derive the chroma intra prediction mode of the current block based on the neighboring reconstructed Y, Cb and Cr samples in the second neighboring row and column. A horizontal gradient and a vertical gradient may be calculated for a (e.g., each) collocated reconstructed luma sample of the current chroma block and the reconstructed Cb and Cr samples. The gradients may be used to build a HoG. The intra prediction mode with the largest histogram amplitude values may be used for performing chroma intra prediction of the current chroma block.

Convolutional cross-component model (CCCM) may be implemented for intra prediction. The CCCM may predict chroma samples from reconstructed luma samples, e.g., similar to CCLM. The reconstructed luma samples may be down-sampled (e.g., as with CCLM) to match the lower resolution chroma grid, for example, if/when chroma sub-sampling is used.

A single model or multi-model variant of CCCM may be used (e.g., similar to CCLM). The multi-model variant may use multiple (e.g., two) models, which may include a model derived for samples above the average luma reference value and another model for the rest of the samples (e.g., similar to CCLM). Multi-model CCCM mode may be selected for PUs that have at least 128 reference samples available.

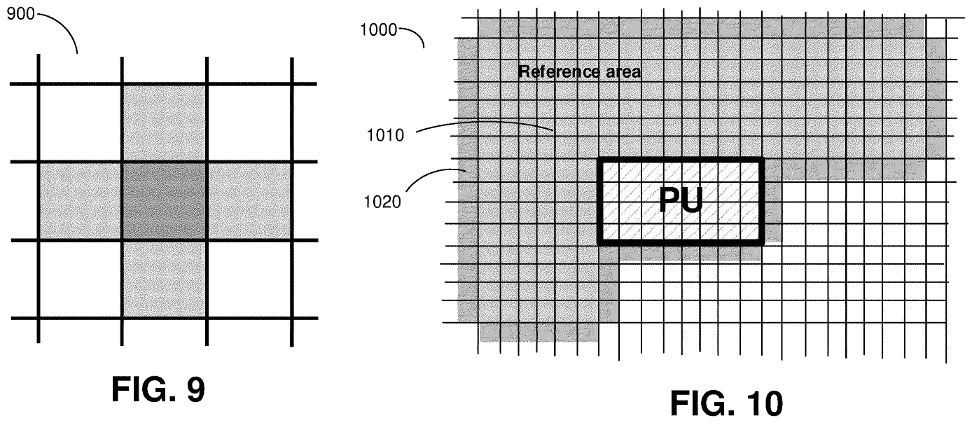

FIG. 9 illustrates an example (900) of a spatial part of a convolutional filter. CCCM may use a convolutional 7-tap filter, which may include a 5-tap plus sign shape spatial component, a nonlinear term, and a bias term. The input to the spatial 5-tap component of the filter may include a center (C) luma sample, which may be collocated with the chroma sample to be predicted and its above/north (N), below/south(S), left/west (W), and right/east (E) neighbors, e.g., as illustrated by example in FIG. 9.

The nonlinear term P may be represented as a power of two of the center luma sample C, e.g., scaled to the sample value range of the content, for example, in accordance with equation (9):

$$P = ( {C}^{*} C + midVal ) ≫ bitDepth \qquad ( 9 )$$

In an example of 10-bit content, the nonlinear term P may be calculated as: P=(C*C+512)>>10. A bias term B may represent a scalar offset between the input and output (e.g., similar to the offset term in CCLM). The bias term B may be set to a middle chroma value or midVal (e.g., 512 for 10-bit content) or other value (e.g., 256 for 10-bit content).

Output of the filter may be calculated as a convolution between the filter coefficients ci and the input values, e.g., clipped to the range of valid chroma samples, for example, in accordance with equation (10):

$$predChromaVal = {c}_{0} C + {c}_{1} N + {c}_{2} S + {c}_{3} E + {c}_{4} W + {c}_{5} P + {c}_{6} B \qquad ( 10 )$$

The filter coefficients ci may be calculated by minimizing mean square error (MSE) between predicted and reconstructed samples (e.g., chroma samples) in the reference area. FIG. 10 illustrates an example 1000 of a reference area (e.g., with its paddings) and a PU. The reference area (e.g., with its paddings) may be used to derive the filter coefficients. An example of the reference area 1010 (e.g., as shown in light grey) may include six (6) lines/columns of chroma samples above and left of the PU. The reference area may extend, for example, one PU width to the right and one PU height below the PU boundaries. The area may be adjusted to include (e.g., only) available samples. The extensions to the reference area 1020 (e.g., as shown in dark grey) may be needed to support the “side samples” of the plus shaped spatial filter. The extensions may be padded, for example, if/when in unavailable areas.

The MSE minimization may be performed, for example, by calculating an autocorrelation matrix for the luma input and a cross-correlation vector between the luma input and chroma output, which may be denoted as aᵢ, where aᵢ=C,N,S,E,W,P,B, e.g., represented as follows:

$${a}_{i} = \{ \begin{matrix}i = 0 : C \\ i = 1 : N \\ i = 2 : S \\ i = 3 : E \\ i = 4 : W \\ i = 5 : P \\ i = 6 : B\end{matrix}$$

The autocorrelation matrix may be LDL decomposed. The final filter coefficients may be calculated, for example, using back-substitution. The process may be similar to the calculation of the ALF filter coefficients. LDL decomposition may be used (e.g., instead of Cholesky decomposition), for example, to avoid using square root operations. The calculation may use (e.g., only) integer arithmetic.

In some examples (e.g., gradient and location based convolutional cross-component model (GL-CCCM)), a GL-CCCM filter for the prediction may be in accordance with equation (11):

$$predChromaVal = {c}_{0} C + {c}_{1} Gy + c 2 Gx + {c}_{3} Y + {c}_{4} X + {c}_{5} P + {c}_{6} B \qquad ( 11 )$$

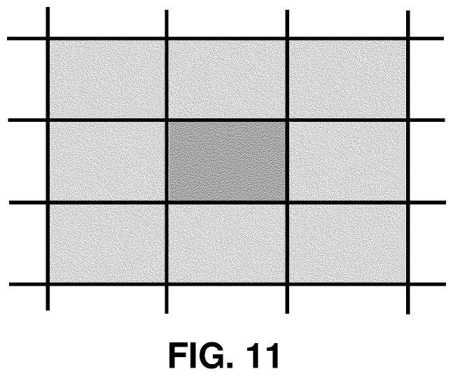

FIG. 11 illustrates an example of spatial samples used for GL-CCCM. With reference to equation (11), Gy and Gx may be the vertical and horizontal gradients, respectively. Gy and Gx may be calculated, respectively, in accordance with equation (12) and equation (13):

$$Gy = ( 2 N + NW + NE ) - ( 2 S + SW + SE ) \qquad ( 12 )$$

$$Gx = ( 2 W + NW + SW ) - ( {2}^{E} + NE + SE ) \qquad ( 13 )$$

The Y and X parameters may be the vertical and horizontal locations of the center luma sample. The Y and X parameters may be calculated with respect to the top-left coordinates of the block.

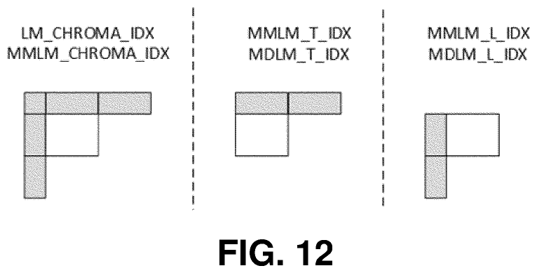

FIG. 12 illustrates an example of neighboring regions used to derive the CC-model.

In some examples, the neighboring region used for selecting the reference samples for deriving the CC-model may be selected among a set of pre-defined regions. For example, the bitstream may signal the selected region among {above+left, above, left}, corresponding to the modes {CHROMA_IDX, T_IDX, L_IDX}, respectively, with the information single model or multi-model mode {MDLM, MMLM}, e.g., as shown by example in FIG. 12.

In some examples, the derivation of the fusing weights of DIMD and/or TIMD may be performed independently for each intra mode. In some examples, intra prediction blending weights for the TIMD and/or DIMD process may be derived, for example, using a regression-based method. Intra prediction samples may be generated from regression-based locally computed parameters on the neighboring samples.

Reconstructed samples and the corresponding predicted samples of a template may be used to determine the blending weights. For example, the weights may be based on minimizing the difference of the predicted samples and the corresponding reconstructed samples of the template.

Regression-based weights may be derived for TIMD. For example, N intra prediction modes may be derived based on a plurality of reconstructed samples of the template. The prediction blocks of the block that correspond to derived intra prediction modes may be obtained.

Denote {aₖ}_{k=0, . . . N-1} the N IPM blending weights used for weighted linear combination of the selected N intra modes Mₖ. An intra prediction model may support/allow deriving the value of intraPred(x) at the location ‘x’ in the template in accordance with equation (14):

$$intraPred ( x ) = {a}_{0} \cdot {M}_{0} ( x ) + {a}_{1} \cdot {M}_{1} ( x ) + ... . + {a}_{N - 1} \cdot {M}_{N - 1} ( x ) + {a}_{N} \cdot B \qquad ( 14 )$$

The weighted and blended predictions of the template that correspond to the derived intra prediction modes may be obtained. The video decoding device may optimize the weights that correspond to the respective derived intra prediction modes based on minimizing the difference of the weighted blended predictions of the template and the reconstructed template.

For example, the values of the IPM blending weights aₖ may be derived (e.g., calculated), for example, by minimizing the difference (e.g., MSE) between predicted and reconstructed samples (x) (e.g., luma samples) in the reference area. The reference area may be, for example, the template area (e.g., as shown in FIG. 6A, 620) or the area used for CCCM (e.g., as shown in FIG. 10, 1010).

In some examples, an additional bias term B may be added (e.g., as a scalar offset). The bias term B may be set to a middle luma value (e.g., 512 for 10-bit content).

The MSE minimization may be performed, for example, by calculating an autocorrelation matrix {m_{i,j}=Σ_{x∈T}Mᵢ(x)·Mⱼ(x)} for the reconstructed luma samples and by calculating a cross-correlation vector {vᵢ=Σ_{x∈T}R(x)·Mᵢ(x)} between the reconstructed luma samples and intra prediction Mₖ samples (e.g., similar to CCCM). The autocorrelation matrix may be LDL decomposed. The final filter coefficients may be calculated using back-substitution.

The intra prediction sample for the current block may be obtained, for example, by applying the intra prediction model (e.g., as shown in equation (14)) with the N intra predictions built with the regular reference samples.

Regression-based weights may be derived for DIMD. The (e.g., two) IPM blending weights (e.g., {a₀, a₁}) for the selected intra DIMD modes, for example, with the tallest histogram bars, and the weight of PLANAR mode {a₂}, may be derived, for example, using a regression-based method (e.g., as described herein). The reference area may be the area used to compute the HoG.

In some examples, the weight for PLANAR may be a fixed pre-determined value and/or the matrix may be 2×2. The value of intraPred(x) may be determined, for example, in accordance with equation (15):

$$intraPred ( x ) = {a}_{0} \cdot {M}_{0} ( x ) + {a}_{1} \cdot {M}_{1} ( x ) + {a}_{2} \cdot {P}_{2} ( x ) \qquad ( 15 )$$

In some examples, a bias may be added.

Regression-based intra prediction may be computed as a linear combination of parameters P (x) derived from the template, for example, in accordance with equation (16):

$$intraPred ( x ) = {a}_{0} \cdot {P}_{0} ( x ) + {a}_{1} \cdot {P}_{1} ( x ) + ... . + {a}_{N - 1} \cdot {P}_{N - 1} ( x ) + {a}_{N} \cdot B \qquad ( 16 )$$

The value of Pₖ(x) may be, for example, the reconstructed reference sample component (e.g., sample luma) in the same column R(col) (e.g., or same line R(lig)) as the sample in the template (e.g., col=column of x, lig=line of x). The value of Pₖ(x) may be, for example, the position (e.g., column (col) or line(lig)) of the reconstructed reference sample.

For example, the parameters may include reconstructed and/or predicted samples that neighbor a sample location. Determining an intra prediction sample for a block or portion of a block (e.g., a unit, a subblock, a sub-subblock) may include applying the determined weights to the reconstructed and/or predicted samples that neighbor the sample location.

For example, a histogram of gradients associated with samples of the template may be obtained. Intra prediction modes may be derived based on the histogram of gradients associated with the template. Prediction samples of the template may be obtained based on the respective derived intra prediction modes, and the parameters may correspond to the prediction samples.

In examples, the weights (e.g., a₀ . . . aₙ) may correspond to the plurality of reference samples of the template. The weights may be optimized based on minimizing a difference of a sum of the weighted reference samples and the reconstructed samples of the template.

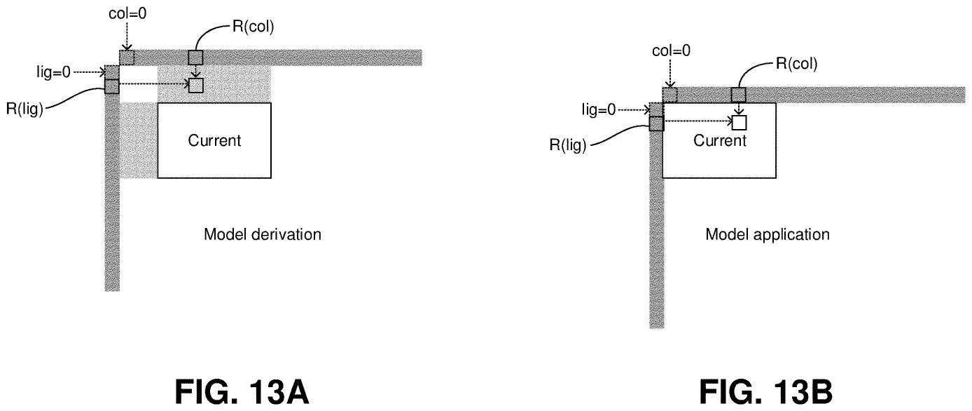

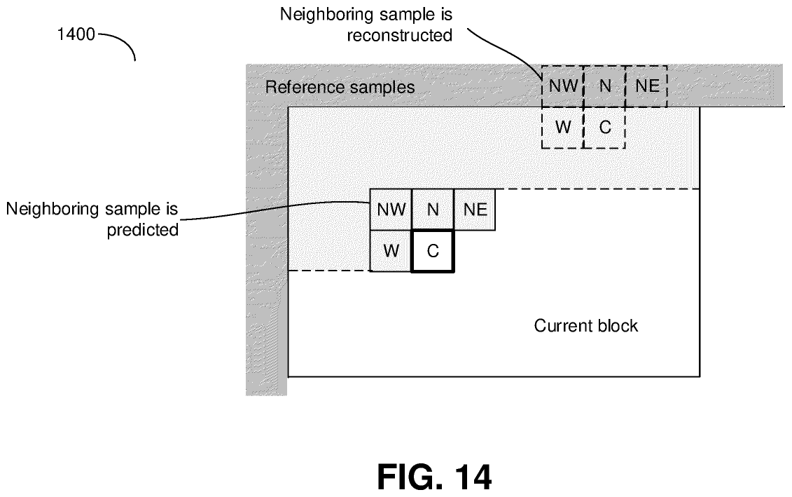

FIG. 13A illustrates an example of using template and reference samples to derive an intra prediction model. FIG. 13B illustrates an example of using reference samples to apply the intra prediction model. FIG. 14 illustrates an example 1400 of applying the prediction model iteratively.

In some examples, the reference samples that may be used to apply the model may be the same as the reference samples used for deriving the model (see, e.g., FIG. 13A). In some examples, the reference samples that may be used to apply the model may be regular intra reference samples (see, e.g., FIG. 13B). In some examples, the reference samples that may be used to derive the model may be the same as reference samples used for applying the model (see, e.g., FIG. 13B).

An advantage of computing intra prediction as a linear combination of parameters P (x) derived from the template is that the intra prediction parameters may depend (e.g., only) on neighboring reference samples. The method may be used, for example, to replace the PLANAR mode and/or as an additional intra prediction mode.

Regression-based iterative intra prediction may be implemented. One or more (e.g., some) parameters P (x) may be derived iteratively from previously predicted sample values of the current block, for example, as depicted by example in FIG. 14. For example, the parameters P(x) may include (e.g., entirely comprise) previously predicted samples. In some examples, the value of Pₖ(x) may be neighboring reconstructed (e.g., if ‘x’ is close to reference sample) or predicted samples. In some examples, the value of Pₖ(x) may (e.g., alternatively) be the local H/V gradient.

Regression-based model derivation may be implemented with local adaptation. As described herein, intra prediction may be adapted spatially, for example, depending on HoG costs (e.g., DIMD) and/or SATD costs (e.g., TIMD). Spatial adaptation may be carried out with spatial weighting. For example, three best intra modes may be derived for TIMD, for example, using above template only, left template only, and both above+left templates. The three templates may be fused with weights, which may vary locally, for example, depending on the distance of the current sample with given templates.

DIMD may use the location (e.g., Left or Above) of the reference samples that contributed to the HoG peaks to derive weights varying locally, for example, depending on the distance of the current sample with the left or above side. In some examples (e.g., as a variant to TIMD), left and above templates may be used to select (e.g., two) intra modes minimizing SATD on the left and above templates, respectively. Weights varying locally, e.g., depending on the distance of the current sample with the left or above side, may be used to perform the final blending of the (e.g., two) intra modes.

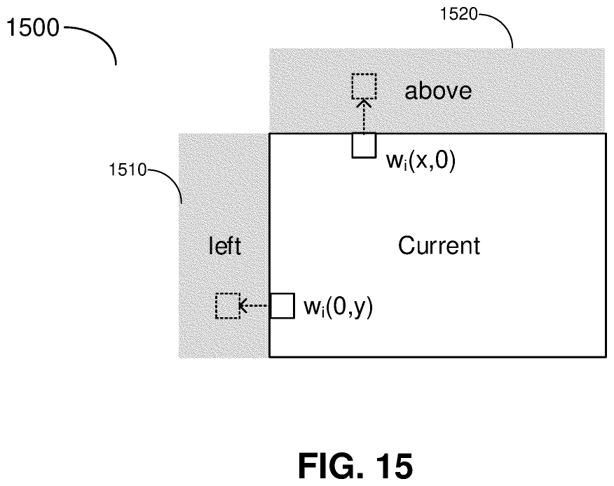

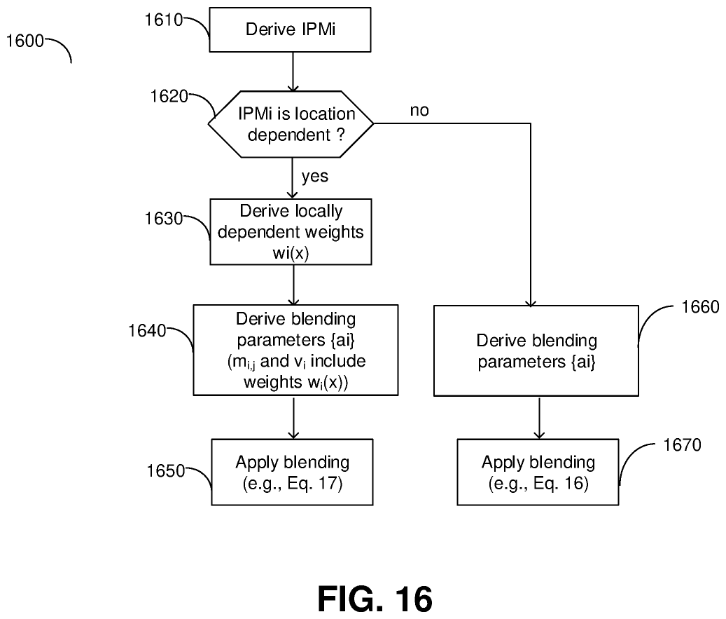

Weighting adaptation may be combined with other examples (e.g., as described herein). FIG. 15 illustrates an example 1500 of using spatial varying weights for deriving the blending model. FIG. 16 illustrates an example 1600 of deriving blending {ai} parameters with spatially varying blending weights {wi(x)}.

As shown in FIG. 16, at 1610 IPMi may be derived. At 1620, IPMi may be evaluated to determine if it is location dependent.

If the IPMi is location dependent, at 1630 locally dependent weights, wi(x), may be derived. At 1640 blending {ai} parameters may be derived. At 1650 blending may be applied (e.g., in accordance with equation (17) below).

If IPMi is not location dependent, at 1660 blending {ai} parameters may be derived (e.g., without locally dependent weights). At 1670, blending may be applied (e.g., in accordance with equation (16) above).

Previous embodiments may be extended to a (e.g., any) spatial adaptation, for example, using spatially adapted weighting wₖ(x) in the IPM blending equation (e.g., as referenced by 1650 in FIG. 16). The IPM blending equation may determine intraPred(x), for example, in accordance with equation (17):

$$intraPred ( x ) = {w}_{0} ( x ) \cdot {a}_{0} \cdot {P}_{0} ( x ) + {w}_{1} ( x ) \cdot {a}_{1} \cdot {P}_{1} ( x ) + ... . + {w}_{N - 1} ( x ) \cdot {a}_{N - 1} \cdot {P}_{N - 1} ( x ) \qquad ( 17 )$$

Spatial weighting may be included while deriving the IPM blending parameters {ai}. The expression of the autocorrelation matrix and the cross-correlation vector {vᵢ=Σ_{x∈T}R(x)·Mᵢ(x)} may be modified (e.g., as referenced by 1640 in FIG. 16), for example, in accordance with equation (18) and equation (19):

$$\{ {m}_{i , j} = {\sum }_{x ∈ T} {w}_{i} ( x ) \cdot {M}_{i} ( x ) \cdot {w}_{j} ( x ) \cdot {M}_{j} ( x ) \} \qquad ( 18 )$$

$$\{ {v}_{i} = {\sum }_{x ∈ T} R ( x ) \cdot {w}_{i} ( x ) \cdot {M}_{i} ( x ) \} \qquad ( 19 )$$

The values of wᵢ(x) may correspond to the value of the spatial weight adaptation of TIMD or DIMD blending for the first column of the current block, e.g., in case of samples of the left template (e.g., as referenced by 1510 in FIG. 15). The values of wᵢ(x) may correspond to the value of the spatial weight adaptation of TIMD or DIMD blending for the first line of the current block, e.g., in case of samples of the above template (e.g., as referenced by 1520 in FIG. 15).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-39. (canceled)

40. A video decoding device comprising:
a processor configured to:
obtain a template associated with a block;
obtain a plurality of predicted samples and a plurality of corresponding reconstructed samples of the template;
determine a plurality of weights based on minimizing a difference of the predicted samples and the corresponding reconstructed samples of the template;
determine an intra prediction model that comprises applying the plurality of weights to a respective plurality of parameters;
determine an intra prediction sample for the block based on the intra prediction model, wherein the predicted samples, the corresponding reconstructed samples, and the intra prediction sample share a component type; and
decode the block based on the intra prediction sample.

41. The device of claim 40, wherein the processor is further configured to:
obtain a plurality of reference samples of the template; and
optimize the plurality of weights that correspond to the plurality of reference samples of the template based on minimizing a difference of a sum of a plurality of weighted reference samples and the reconstructed samples of the template.

42. The device of claim 41, wherein the intra prediction sample is associated with a sample location in the block, the plurality of parameters comprises a plurality of predicted samples that neighbor the sample location, and the determination of the intra prediction sample for the block based on the intra prediction model comprises the processor being configured to:
apply the plurality of determined weights to the plurality of predicted samples that neighbor the sample location.

43. The device of claim 41, wherein the intra prediction sample is a first intra prediction sample that is associated with a first sample location in the block, the plurality of parameters comprises a plurality of reconstructed samples that neighbor the first sample location, and the processor is further configured to:
for a second sample location in the block, identify a plurality of predicted samples that neighbor the second sample location; and
apply the plurality of determined weights to the plurality of predicted samples to determine a second intra prediction sample for the block, wherein the block is decoded further based on the second intra prediction sample of the block.

44. The device of claim 43, wherein the plurality of predicted samples that neighbor the second sample location comprises the first intra prediction sample.

45. The device of claim 40, wherein the processor is further configured to:
derive a plurality of intra prediction modes based on a plurality of reconstructed samples of the template and a plurality of reference samples of the template, wherein the plurality of parameters correspond to a plurality of prediction samples obtained based on the plurality of derived intra prediction modes, and wherein the determination of the intra prediction sample for the block based on the intra prediction model comprises the processor being configured to:
apply the plurality of weights to the plurality of prediction samples obtained based on the plurality of derived intra prediction modes.

46. The device of claim 40, wherein the processor is further configured to:
obtain a histogram of gradients associated with a plurality of samples of the template; and
derive a plurality of intra prediction modes based on the histogram of gradients associated with the plurality of samples of the template, wherein the plurality of samples of the template are obtained based on the respective derived intra prediction modes, and wherein the plurality of parameters corresponds to a plurality of prediction samples obtained based on the plurality of derived intra prediction modes.

47. The device of claim 40, wherein the processor is further configured to:
derive a plurality of intra prediction modes based on at least on a plurality of reconstructed samples of the template;
obtain a plurality of prediction blocks of the block based on the plurality of derived intra prediction modes; and
blend the plurality of prediction blocks based on the plurality of weights.

48. The device of claim 40, wherein the processor is further configured to:
derive a plurality of intra prediction modes based on at least on the template associated with the block;
obtain a plurality of weighted and blended predictions of the template based on the plurality of derived intra prediction modes; and
optimize the plurality of weights that correspond to the plurality of derived intra prediction modes based on minimizing a difference of the plurality of weighted and blended predictions of the template and the template.

49. A method comprising:
obtaining a template associated with a block;
obtaining predicted samples and corresponding reconstructed samples of the template;
determining a plurality of weights based on minimizing a difference of the predicted samples of the template and the corresponding reconstructed samples;
determining an intra prediction model that comprises applying the plurality of weights to a respective plurality of parameters;
determining an intra prediction sample for the block based on the intra prediction model, wherein the predicted samples, the corresponding reconstructed samples, and the intra prediction sample share a component type; and
decoding the block based on the intra prediction sample.

50. The method of claim 49, further comprising:
obtaining a plurality of reference samples of the template; and
optimizing the plurality of weights that correspond to the plurality of reference samples of the template based on minimizing a difference of a sum of a plurality of weighted reference samples and the reconstructed samples of the template.

51. The method of claim 11, wherein the intra prediction sample is associated with a sample location in the block, the plurality of parameters comprises a plurality of predicted samples that neighbor the sample location, and determining the intra prediction sample for the block based on the intra prediction model comprises:
applying the plurality of determined weights to the plurality of predicted samples that neighbor the sample location.

52. The method of claim 50, wherein the intra prediction sample is a first intra prediction sample that is associated with a first sample location in the block, the plurality of parameters comprises a plurality of reconstructed samples that neighbor the first sample location, and the method further comprises:
for a second sample location in the block, identifying a plurality of predicted samples that neighbor the second sample location; and
applying the plurality of determined weights to the plurality of predicted samples to determine a second intra prediction sample for the block.

53. The method of claim 49, further comprising:
deriving a plurality of intra prediction modes based on a plurality of reconstructed samples of the template and a plurality of reference samples of the template, wherein the plurality of parameters correspond to a plurality of prediction samples obtained based on the plurality of derived intra prediction modes, and wherein determining the intra prediction sample for the block based on the intra prediction model comprises:
applying the plurality of weights to the plurality of prediction samples obtained based on the plurality of derived intra prediction modes.

54. The method of claim 49, further comprising:
deriving a plurality of intra prediction modes based on a plurality of reconstructed samples of the template, wherein the plurality of prediction samples of the template is obtained based on the respective derived intra prediction modes, and wherein the plurality of parameters corresponds to a plurality of prediction samples obtained based on the plurality of derived intra prediction modes.

55. The method of claim 49, further comprising:
deriving a plurality of intra prediction modes based on at least on a plurality of reconstructed samples of the template;
obtaining a plurality of prediction blocks of the block based on the plurality of derived intra prediction modes; and
blending the plurality of prediction blocks based on the plurality of weights.

56. The method of claim 49, further comprising:
deriving a plurality of intra prediction modes based on at least on the template associated with the block;
obtaining a plurality of weighted and blended predictions of the template based on the plurality of derived intra prediction modes; and
optimizing the plurality of weights that correspond to the plurality of derived intra prediction modes based on minimizing a difference of the plurality of weighted and blended predictions of the template and the template.

57. A video encoding device comprising:
a processor configured to:
obtain a template associated with a block;
obtain a plurality of predicted samples and a plurality of corresponding reconstructed samples of the template;
determine a plurality of weights based on minimizing a difference of the predicted samples and the corresponding reconstructed samples of the template;
determine an intra prediction model that comprises applying the plurality of weights to a respective plurality of parameters;
determine an intra prediction sample for the block based on the intra prediction model, wherein the predicted samples, the corresponding reconstructed samples, and the intra prediction sample share a component type; and
encode the block based on the intra prediction sample.

58. The device of claim 57, wherein the processor is further configured to:
obtain a plurality of reference samples of the template; and
optimize the plurality of weights that correspond to the plurality of reference samples of the template based on minimizing a difference of a sum of a plurality of weighted reference samples and the reconstructed samples of the template.

59. The device of claim 19, wherein the intra prediction sample is a first intra prediction sample and is associated with a first sample location in the block, the plurality of parameters comprises a plurality of reconstructed samples that neighbor the first sample location, and the processor is further configured to:
for a second sample location in the block, identify a plurality of predicted samples that neighbor the second sample location; and
apply the plurality of determined weights to the plurality of predicted samples to determine a second intra prediction sample for the block, wherein the block is decoded further based on the second intra prediction sample of the block.
